(19) United States
(12) Patent Application Publication
(10) Pub. No.: US 2021/0194639 A1
(43) Pub. Date: Jun. 24, 2021

(54) FLEXIBLY DETERMINING A REORDERING VALUE FOR RADIO LINK CONTROL PROTOCOL DATA UNIT RETRANSMISSIONS

(71) Applicant: QUALCOMM iNCORPORATED, San Diego, CA (US)

(72) Inventors: Hong Yu, Beijing (CN); Long Duan, San Diego, CA (US)

(21) Appl. No.: 16/077,715

(22) PCT Filed: Mar. 18, 2016
(86) PCT No.: PCT/CN2016/076707

§ 371 Date: Aug. 13, 2018

(51) Int. Cl. H04L 1/18; H04L 1/20

(52) U.S. Cl. CPC H04L 1/1825; H04L 1/1848; H04L 1/1835; H04L 1/20; H04L 1/1896

(57) ABSTRACT

Methods, systems, and devices for wireless communication are described. A device may tailor its operations to different configurations or conditions by adjusting procedures associated with a radio link control (RLC) layer by reference to a value defined at a medium access control (MAC) layer. The device may, for example, receive from a network a value for a timer associated with the retransmission of RLC packet data units (PDUs). The device may adjust the timer value based on a radio resource configuration or channel conditions, such as a number of RLC PDUs discarded or retransmitted in an interval defined by one or more MAC layer operations. In some examples, a ratio of discarded and retransmitted RLC PDUs and an interval for hybrid automatic repeat request (HARQ) retransmissions is used as basis for determining channel conditions and thus for selecting a timer value for RLC PDU retransmission.

### CROSS REFERENCES

The present application for patent claims priority to International Patent Application No. PCT/CN2016/076707 to Yu et. al., titled “FLEXIBLY DETERMINING A REORDERING VALUE FOR RADIO LINK CONTROL PROTOCOL DATA UNIT RETRANSMISSIONS”, filed Mar. 18, 2016, assigned to the assignee hereof, which is hereby incorporated by reference in its entirety.

### BACKGROUND

The present disclosure, for example, relates to wireless communication systems and more particularly to techniques for flexibly determining a reordering value for radio link control (RLC) protocol data unit (PDU) retransmissions.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may each be referred to as a user equipment (UE).

A wireless communication system may use a number of techniques to increase the reliability of a communication link, including packet retransmissions. Different layers of a wireless communication protocol stack may be used to conduct different aspects of the retransmission process. For instance, the medium access control (MAC) layer may use a hybrid automatic repeat request (HARQ) process to perform multiple retransmissions of a transport block. A transport block may include one or more RLC protocol data units (PDUs), each of which may be assigned a sequence number (SN). While the RLC layer may use an acknowledged mode (AM) as an outer-loop retransmission mechanism to recover RLC PDUs that are associated with failed transport blocks.

Failed transport block transmissions may result in the associated RLC PDUs being delivered out-of-order to a receiving RLC entity. Upon identification of an out-of-order RLC PDU, the receiving RLC entity may trigger a reordering timer, and, at the expiration of the reordering timer, may transmit a status report detailing the received/missing RLC PDUs to the RLC entity on the transmitting side. The reordering timer used at the receiving RLC entity may be set based on a value received from the network, and once received the reordering timer duration corresponding to the value is fixed at the receiving RLC entity. But the network-determined reordering timer value may fail to account for device-specific variables or the timer may be based on too coarse of measurements and may lead to suboptimal performance.

### SUMMARY

A device may tailor its operations to different configurations or conditions by adjusting procedures associated with an RLC layer by reference to a value defined at a MAC layer. A device may receive a value for a timer that is associated with RLC packet reordering operations, and the device may adjust the timer value based on channel conditions or other device-specific conditions or operations. For example, the device may adjust the timer value based on a radio resource configuration, such as a carrier configuration, or channel conditions, such as a number of RLC PDUs discarded or retransmitted in one or more intervals defined by MAC layer operations. In some cases, the device determines channel conditions for a UE by determining a ratio of discarded to retransmitted RLC PDUs during one or more intervals defined with reference to the duration of a HARQ process.

A method of wireless communication is described. The method may include receiving, from a wireless network, a first value for a timer associated with retransmissions of radio link control (RLC) packet data units (PDUs), determining a second value for the timer based at least in part on a channel condition of the UE or a radio resource configuration of the UE, or both and processing RLC protocol data units (PDUs) based at least in part on the second value for the timer.

An apparatus for wireless communication is described. The apparatus may include means for receiving, from a wireless network, a first value for a timer associated with retransmissions of RLC packet data units (PDUs), means for determining a second value for the timer based at least in part on a channel condition of the UE or a radio resource configuration of the UE, or both and means for processing RLC PDUs based at least in part on the second value for the timer.

A further apparatus is described. The apparatus may include a processor, memory in electronic communication with the processor, and instructions stored in the memory. The instructions may be operable to cause the processor to receive, from a wireless network, a first value for a timer associated with retransmissions of RLC packet data units (PDUs), determine a second value for the timer based at least in part on a channel condition of the UE or a radio resource configuration of the UE, or both and process RLC PDUs based at least in part on the second value for the timer.

A non-transitory computer readable medium for wireless communication is described. The non-transitory computer-readable medium may include instructions to cause a processor to receive, from a wireless network, a first value for a timer associated with retransmissions of RLC packet data units (PDUs), determine a second value for the timer based on a channel condition of the UE or a radio resource configuration of the UE, or both and process RLC PDUs based on the second value for the timer.

Some examples of the method, apparatus, or non-transitory computer-readable medium described above may further include processes, features, means, or instructions for determining the channel condition of the UE based on a number of discarded RLC PDUs or a number of retransmitted RLC PDUs, or both.

In some examples of the method, apparatus, or non-transitory computer-readable medium described above, determining the channel condition of the UE includes determining a ratio of discarded RLC PDUs to retransmitted RLC PDUs. In some examples of the method, apparatus, or non-transitory computer-readable medium described above, the duration of the hybrid automatic repeat request (HARQ) process is associated with a maximum number of HARQ retransmissions.

In some examples of the method, apparatus, or non-transitory computer-readable medium described above, the number of discarded RLC PDUs or the number of retransmitted RLC PDUs, or both, is based on a duration of a HARQ process. In some examples of the method, apparatus, or non-transitory computer-readable medium described above, determining the second value for the timer includes selecting the second value for the timer from a set of values that comprise the first value for the timer and the second value for the timer, where the second value for the timer is selected based on the first value for the timer, the channel condition, or the radio resource configuration of the UE, or any combination thereof. In some examples, the second value for the timer is determined based at least in part on a duration defined with respect to media access control (MAC) layer operations.

In some examples of the method, apparatus, or non-transitory computer-readable medium described above, determining the second value for the timer includes determining that the channel condition is greater than a threshold. Some examples of the method, apparatus, or non-transitory computer-readable medium described above may further include processes, features, means, or instructions for selecting the second value for the timer based on determining that the channel condition is greater than the threshold, where the second value for the timer is greater than the first value for the timer.

In some examples of the method, apparatus, or non-transitory computer-readable medium described above, determining the channel condition is greater than the threshold includes comparing a ratio of discarded RLC PDUs to retransmitted RLC PDUs with the threshold. In some examples of the method, apparatus, or non-transitory computer-readable medium described above, determining the second value for the timer includes determining that the channel condition is less than a threshold. Some examples of the method, apparatus, or non-transitory computer-readable medium described above may further include processes, features, means, or instructions for selecting the second value for the timer based on determining that the channel condition is less than the threshold, where the second value for the timer is less than the first value for the timer.

In some examples of the method, apparatus, or non-transitory computer-readable medium described above, a radio resource configuration of the UE comprises a multi-carrier configuration. Some examples of the method, apparatus, or non-transitory computer-readable medium described above may further include processes, features, means, or instructions for receiving signaling that indicates a change in the radio resource configuration of the UE, where the second value for the timer is determined based on the change in the radio resource configuration. In some examples, the second value for the timer is determined based at least in part on a duration defined with respect to MAC layer operations.

### BRIEF DESCRIPTION OF THE DRAWINGS

FIG. 1 illustrates an example of a wireless communications system that supports flexibly determining a reordering value for radio link control (RLC) protocol data unit (PDU) retransmissions in accordance with various aspects of the present disclosure;

FIG. 2 illustrates an example of a radio protocol architecture for a wireless communications network that supports flexibly determining a reordering value for RLC PDU retransmissions in accordance with various aspects of the present disclosure;

FIG. 3 illustrates an example of a wireless communication subsystem that supports flexibly determining a reordering value for RLC PDU retransmissions in accordance with various aspects of the present disclosure;

FIGS. 4A and 4B illustrates an example of a process flows for flexibly determining a reordering value for RLC PDU retransmissions in accordance with various aspects of the present disclosure;

FIGS. 5 through 7 show block diagrams of a wireless device or devices that supports flexibly determining a reordering value for RLC PDU retransmissions in accordance with aspects of the present disclosure;

FIG. 8 illustrates a block diagram of a system including a UE that supports flexibly determining a reordering value for RLC PDU retransmissions in accordance with aspects of the present disclosure; and

FIGS. 9 through 11 illustrate methods for flexibly determining a reordering value for RLC PDU retransmissions in accordance with aspects of the present disclosure.

### DETAILED DESCRIPTION OF THE INVENTION

A device may receive from a network a value for a timer associated with the retransmission of RLC packet data units (PDUs), and the device may adjust the received timer value because it may fail to compensate for variations in the conditions of a channel. The network-specified timer may, for example, fail to account or compensate for changes in the location of a mobile device within a system. The device may tailor its operations to different configurations or conditions by adjusting procedures associated with a radio link control (RLC) layer by reference to a value defined at a medium access control (MAC) layer.

By way of example, a UE and a base station may each have receiving and transmitting RLC entities that manage outer loop retransmission procedures. The UE may receive, from the network, a value for a timer that is associated with outer loop RLC PDU retransmissions, and the UE may adapt this value based on channel conditions at the UE or a radio resource configuration of the UE. In some cases, the UE may keep track of the number of retransmitted RLC PDUs and the number of received RLC PDUs that are discarded or duplicative. The UE may compute a ratio of discarded RLC PDUs to retransmitted RLC PDUs within an interval defined by a medium access control (MAC) operation. For instance, the IE may compute the ratio of discarded to retransmitted RLC PDUs within a duration defined by a hybrid automatic repeat request (HARQ) process.

The computed ratio may be indicative of channel conditions experienced at the UE. For instance, a high ratio may be associated with preferred channel conditions. In some cases, the ratio may be compared with a threshold, and if the ratio exceeds the threshold, the UE may increment the received reordering timer value. If the ratio is below the threshold, the UE may decrement the received reordering timer value.

Aspects of the disclosure introduced above are described next in the context of a wireless communication system. Example communications protocol architectures and subsystems are then described. Aspects of the disclosure are further illustrated by and described with reference to apparatus diagrams, system diagrams, and flowcharts that relate to flexibly determining a reordering value for RLC PDU retransmissions.

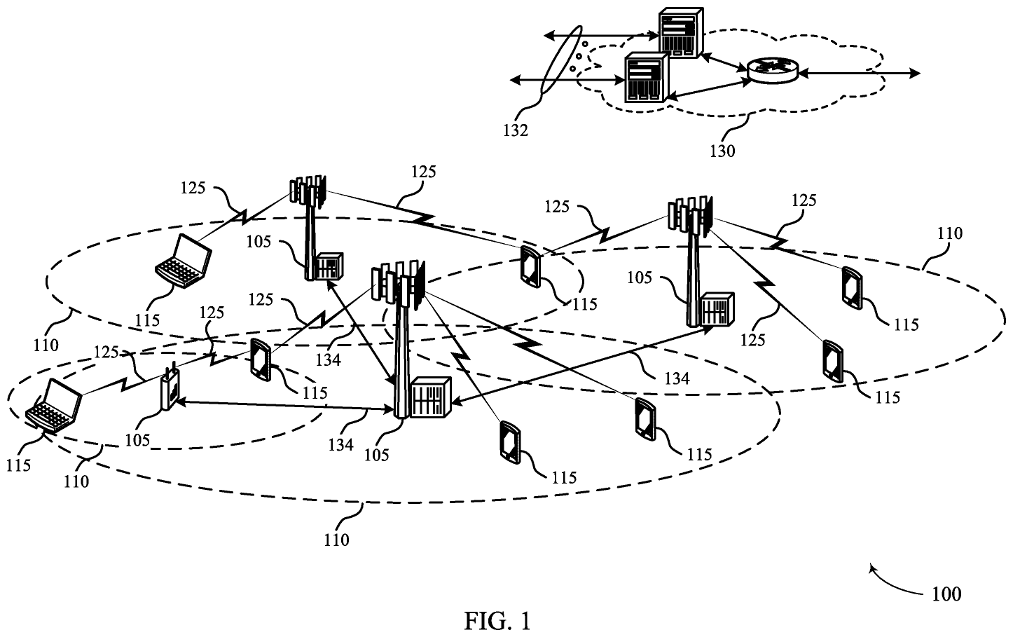

FIG. 1 illustrates an example of a wireless communications system 100 that supports flexibly determining a reordering value for RLC PDU retransmissions in accordance with various aspects of the present disclosure. The wireless communications system 100 includes base stations 105, UEs 115, and a core network 130. In some examples, the wireless communications system 100 may be a Long Term Evolution (LTE)/LTE-Advanced (LTE-A) network. Wireless communications system 100 may implement aspects of and support the flexible determination of a reordering value for RLC PDU retransmissions.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a IE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, a machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105. Base stations 105 may transmit signaling that includes network-specified values for a reordering timer, as described herein.

In some cases, wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier.” “cell,” and “channel” may be used interchangeably herein. A UE 115 may be configured with multiple downlink CCs and one or more uplink CCs for carrier aggregation. Carrier aggregation may be used with both FDD and TDD component carriers. A carrier aggregation configuration, or other carrier configuration, may be used as a basis for determining or adjusting a reordering timer.

Wireless communications system 100 may also utilize one or more enhanced component carriers (eCCs). An eCC may be characterized by one or more features including: flexible bandwidth, different transmission time intervals (TTI), and modified control channel configuration. In some cases, an eCC may be associated with a carrier aggregation (CA) configuration or a dual connectivity configuration (e.g., when multiple serving cells have a suboptimal backhaul link). An eCC may also be configured for use in unlicensed spectrum or shared spectrum (e.g., where more than one operator is licensed to use the spectrum).

As described further below, wireless communications system 100 may be a packet-based network that operates according to a layered protocol stack. In the user plane, communications at a bearer or packet data convergence protocol (PDCP) layer may be internet protocol (IP) based. A radio resource control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARQ) to provide retransmission at the MAC layer to improve link efficiency. In the control plane, the radio resource control (RRC) protocol layer may provide establishment, configuration, and maintenance of an RRC connection between a UE 115 and the base stations 105 or core network 130 supporting radio bearers for the user plane data. At the physical (PHY) layer, the transport channels may be mapped to physical channels.

The RLC, for both a UE 115 and a base station 105, may include multiple RLC entities (e.g., a transmitting and receiving RLC PDUs). In some cases, the RLC layer may also be used to manage retransmissions of missing RLC PDUs that have been exchanged between a base station 105 and a UE 115. For instance, a transmitting RLC entity may include sequencing information with an RLC PDU—e.g., by including a sequence number (SN) in an RLC header. In some cases, the HARQ processes may deliver transport blocks to the receiving MAC entity out of order, and accordingly the RLC PDUs associated with the transport block may also be received out of order. These out-of-order transport blocks may be passed from the MAC layer to the receiving RLC entity, and the UE's 115 receiving RLC entity may identify that an RLC PDU has been received out of order—e.g., has a greater associated SN than expected.

Consequently, the RLC entity may trigger a reordering timer, which may be associated with retransmission of RLC PDUs. For instance, if the reordering timer expires prior to the missing RLC PDU—e.g., the RLC PDU with the expected SN—being delivered, the UE's 115 transmitting RLC entity may send a status report to the corresponding base station's 105 receiving RLC entity. The status report may inform the base station 105 of which RLC PDUs have been successfully delivered, and the base station 105 may determine which RLC PDUs have not, or vice versa. Accordingly, the base station 105 may retransmit the missing RLC PDUs to the UE 115.

In some cases, the network may provide each UE 115 within a coverage area 110 with a value to use for the reordering timer. A UE 115 may use the received value at some or all locations within the coverage area 110, unless the network provides a different value at a later point in time. However, the values received from the network may not compensate for different channel conditions experienced by the UE 115 at different locations of the coverage area 110, which may increase the number of retransmissions and/or the receipt of duplicate RLC PDUs, decreasing throughput. In some cases, a UE 115, may modify a received reordering timer value based on channel conditions experienced by the wireless device. For example, a UE 115 may receive a first value for a reordering timer, determine a second value for the reordering timer based on a channel condition or a radio resource configuration of UE 115, and use the second value for processing missing RLC PDUs. In this way, a wireless device may adapt to variable channel conditions within a coverage area 110.

On the uplink, a base station 105 may use a predetermined value for a reordering timer associated with the retransmission of uplink RLC transmission and reception. And in some cases, the same adaptive reordering timer adjustment can be applied at the base station 105. That is, the base station 105 may modify the default reordering timer value based on channel conditions between the base station 105 and a UE 115 on the uplink or a radio resource configuration of a UE 115. For example, a base station 105 may have a first value for a reordering timer, determine a second value for the reordering timer based on a channel condition or a radio resource configuration of a corresponding UE 115, and use the second value for processing missing RLC PDUs. In some cases, the first value may be predetermined for a UE 115 or for a group of UEs 115. In this way, the base station 105 may adapt to variable channel conditions associated with individual UEs 115 within a coverage area 110. Although generally discussed in the context of downlink behavior below for the sake of simplicity, the following discussion may be similarly applied at a base station for the uplink.

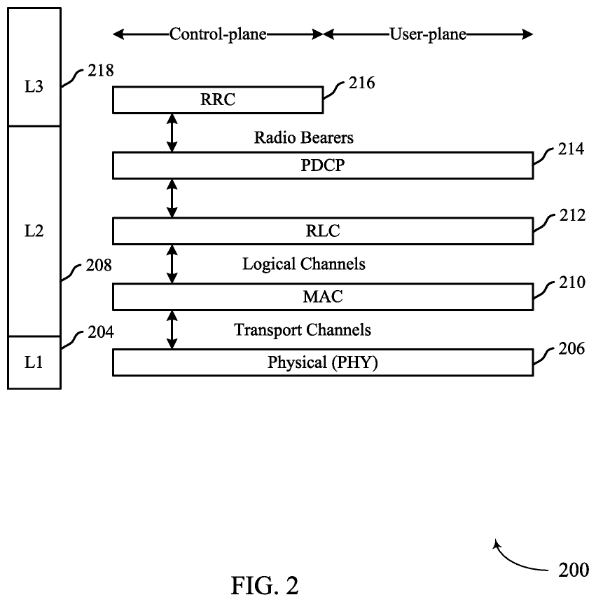

FIG. 2 illustrates an example of a radio protocol architecture 200 for a wireless communications network that supports flexibly determining a reordering value for RLC PDU retransmissions in accordance with various aspects of the present disclosure. The radio protocol architecture 200 may include three layers: Layer 1 (L1) 204, which may be referred to as the physical layer, Layer 2 (L2) 208, and Layer 3 (L3) 218, which may be referred to as the RRC layer.

The radio protocol architecture 200 may be implemented with a UE and a base station, such as a UE 115 and a base station 105 as described with reference to FIG. 1. L3 218 may configure signaling protocols that are used by a UE and base station for transmissions across L1 204, while L2 208 may process and prepare control and user data for transmission across L1 204. A UE may use the information provided by the upper two layers to prepare uplink transmissions to a base station. L1 204 may be the lowest layer and may implement various physical layer signal processing functions. L1 204 may include the physical sublayer 206. L2 208 may be located above L1 204 and may be responsible for the link between a UE and a base station over the physical sublayer 206. L2 208 may include a PDCP sublayer 214, an RLC sublayer 212, and a MAC sublayer 210, which may be terminated at the base station on the network side. L3 218 may include an RRC sublayer 216.

In the user plane, L3 218 may be a network layer (e.g., IP layer) that may be terminated at the PDN gateway on the network side or may be an application layer that may be terminated at the other end of the connection (e.g., far end UE, server, etc.). A UE may be capable of providing multiple different services to a user such as, for example, voice communications, text messages, email access, network access to remote networks such as the Internet, and file transfers to/from remote computers, to name a few. In the control plane, a base station may include an RRC sublayer 216 in L3 218. The RRC sublayer 216 may be responsible for obtaining radio resources (i.e., radio bearers) and for configuring the lower layers using RRC signaling between the base station and the UE.

The PDCP sublayer 214 may provide multiplexing between different radio bearers and logical channels. The PDCP sublayer 214 may also provide header compression for upper layer data packets to reduce radio transmission overhead, security by ciphering the data packets, and handover support for UEs between base stations. The RLC sublayer 212 may provide segmentation and reassembly of upper layer data packets, retransmission of lost data packets, and reordering of data packets to compensate for out-of-order reception due to HARQ. For example, the RLC sublayer 212 may receive user data in the form of service data units (SDUs), and may segment, concatenate, and reassemble the SDUs into RLC PDUs. The RLC sublayer 212 may also assign a sequence number to each RLC PDU. The RLC entities may operate in a number of different modes including transparent mode (TM), unacknowledged mode (UM), and acknowledged mode (AM).

For TM the RLC sublayer 212 may be bypassed and the RLC may refrain from performing segmentation, reassembly, and retransmission operations. TM may be used for data sent over control channels that do not illicit feedback, such as the broadcast control channel (BCCH), the common control channel (CCCH), and the paging control channel (PCCH). UM may support segmentation, reassembly, and in-sequence delivery. UM may be used to provide services that can sufficiently operate with transmission errors (e.g., VoIP, etc.). AM may support segmentation, reassembly, in-sequence delivery, and retransmissions of missing data. AM may be used for services that benefit from in-sequence deliver (e.g., streaming applications, etc.). The RLC sublayer 212 may pass RLC PDUs to the MAC sublayer 210 through logical channels

The RLC PDUs received at the MAC sublayer 210 may be referred to as MAC SDUs, and the MAC sublayer 210 may construct MAC PDUs including one or more MAC SDUs. The MAC sublayer 210 may be responsible for allocating the various radio resources (e.g., resource blocks) in one cell among the UEs. The MAC PDUs may be included in transport blocks, which may be mapped to the various resources. The MAC sublayer 210 may also provide multiplexing between logical and transport channels, and may format and send the logical channel data to the physical sublayer 206 through transport channels. The MAC sublayer 210 may additionally perform logical channel prioritization and may be responsible for hybrid automatic repeat request (HARQ) operations.

HARQ may be used to increase the likelihood that a transport block is correctly received at a device. In some cases. HARQ may include a combination of error detection (e.g., using a CRC), forward error correction (FEC), and retransmission (e.g., automatic repeat request (ARQ)) to improve throughput at the MAC layer in poor radio conditions (e.g., signal-to-noise conditions). For example, if a portion of the transport block is not sent correctly, the receiving device (e.g., a UE) may respond to the transmitting device (e.g., a base station) with a NACK. Ater receiving a NACK, the base station may retransmit the entire transport block, including correctly decoded information. Each retransmission of a transport block may be considered a subsequent redundancy version (RV) (i.e., a new transport block is RV 0, a first retransmission of the transport block is RV 1, a second retransmission of the transport block is RV 2, etc.). If the redundancy version exceeds a threshold, the base station may abandon transmission of the transport block. The duration associated with transmitting a transport block and all subsequent redundancy versions may be referred to as a maximum HARQ process duration, the length in time of which may be set by the MAC layer.

In some examples, HARQ transmissions may deliver one or more MAC PDUs out-of-order. Out-of-order delivery may be a result of abandoned transmissions or variations in channel conditions that affect certain transport blocks but not others. Out-of-order delivery of MAC PDUs to a receiving MAC entity may result in out-of-order delivery of RLC PDUs to a receiving RLC entity. In order to decrease the frequency of out-of-order deliveries to the receiving RLC entity, the MAC layer may implement in-sequence delivery techniques to facilitate in-order delivery to the RLC layer. For instance, the MAC layer may assign a transport sequence number (TSN)—e.g., from 0 through 63—to each MAC PDU. A receiving MAC entity may additionally use a receive buffer that accepts a certain range of TSNs (e.g., 30-50). If a MAC PDU associated with a TSN that is outside the range of TSNs is identified, then the receive buffer may be updated and a Ti timer may be started. At the expiration of the T1 timer, the MAC layer may identify that one or more MAC PDUs has been received out-of-order and may send a status report to the transmitting MAC entity identifying the MAC PDUs that have been successfully received. The transmitting MAC entity may then retransmit the missing MAC PDUs in response to the received status report.

In poor channel conditions MAC PDUs may be received out-of-order or outside of a receive buffer, and the in-sequence delivery techniques may result in increased delays. In some cases, after temporarily losing a radio connection, a MAC entity may determine whether the next received MAC PDU is assigned the next expected TSN and/or whether the TSN is within the range of the receive buffer. In some cases, if the TSN of the received MAC PDU M is outside the range of the receive buffer, the receiving MAC entity may update the buffer so that next expected TSN is TSN M+1. Otherwise, the receiving MAC entity may trigger the T1 timer. In this way, a receiving MAC entity may identify transmission errors and adjust the range of the receive buffer to be in sync with the transmitting MAC entity without triggering the T1 timer. However, updating the range of the MAC receive buffer may not account for delay associated with a suboptimal duration of the T1 timer.

Furthermore, in some wireless communication systems, such as LTE, the reordering process for in-sequence delivery is implemented at the RLC layer and not the MAC layer. In other communication schemes, a MAC layer receive window location may be adjusted based on observed or detected channel conditions. In such cases, adjusting the receive window location may address so-called window stalling at the MAC layer to due to short-period channel degradation. For instance, if the channel degrades momentarily, there may not be packets sent or received, so the receive window may not move. RLC packets may thus be dropped because the transmitter and receiver may be out of sync—i.e., the transmitter may be sending a new range of sequence numbers while the receiver is still expecting an old range of sequence numbers due to the window stalling. In some cases, window stalling may be addressed by anticipating channel condition degradation and enforcing a condition that keeps the receive window moving. But LTE may not be susceptible to such window stalling issues because reordering may be performed by the RLC layer, rather than the MAC layer, and the RLC layer receive window may be large enough so stalling is not a significant concern. Thus, issues associated with reordering timer values may differ and may warrant the solutions described herein.

As discussed above, receiving an RLC PDU with an unexpected SN (e.g., a greater SN than expected) may result in the triggering of a reordering timer. The value of the reordering timer may be determined by the network and may thus not account for channel variations experienced by a UE. Therefore, in some cases, the value set by the network may result in longer RLC transmission delays than necessary. For example, in poor channel conditions, where a large number of transport blocks are not delivered within the maximum HARQ process duration, a large reordering timer value may not increase the likelihood of receiving an RLC PDU and may result in increased RLC retransmission delay. While, by decreasing the reordering timer value at the UE, the duration of the reordering timer may be shorter than maximum HARQ process duration, and the UE may increase RLC retransmissions and decrease RLC transmission delay without substantially increasing the number of discarded/duplicate RLC PDUs received. That is, by adapting the reordering timer value to yield a higher or lower volume of retransmissions or by modulating the delay between retransmissions based on channel conditions, the UE may increase the number of successfully received RLC PDUs, while minimizing discarded RLC PDUs.

Discarded RLC PDUs may refer to a retransmission of an original RLC PDU that is successfully received by the UE when a status report is triggered prior to the end of the original HARQ process, in addition to the UE receiving the original RLC PDU within the maximum number of original HARQ retransmissions. A substantial increase in the number of discarded RLC PDUs may be determined by comparing a ratio of discarded packets to retransmitted packets against a threshold value. The threshold value may be determined by calculating whether the discarded packets transmissions increase transmission delay within a percent value of an original calculated transmission delay (e.g., <10%).

In some examples, the value set by the network may result in an increased number of unnecessary/duplicate RLC transmissions being discarded at the UE. Duplicate transmissions may unnecessarily use resources and may prevent new data from being transmitted, increasing transmission delay. For example, if a large number of transport blocks are delivered within the maximum HARQ process duration, but after the expiration of the reordering timer, the short reordering timer value may result in increased duplicate RLC transmissions. Certain radio resource configurations used by a UE, such as carrier aggregation, may be associated with increased HARQ process lengths, and may increase the duration associated with a maximum number of HARQ retransmissions relative to a received reordering timer value. However, by increasing, at the UE, the reordering timer value so that the duration of the reordering timer value is greater than or closer to the duration associated with a maximum number of HARQ retransmissions, the UE may decrease the number of duplicate transmissions and increase RLC throughput.

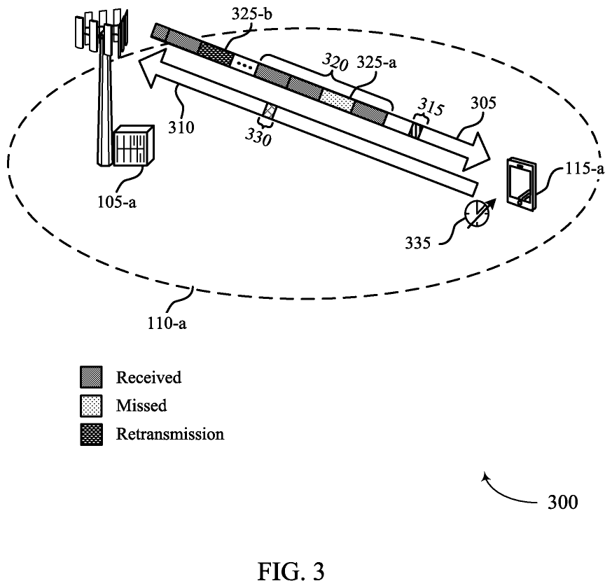

FIG. 3 illustrates an example of a wireless communications subsystem 300 that supports flexibly determining a reordering value for RLC PDU retransmissions in accordance with various aspects of the present disclosure. Wireless communications subsystem 300 may include UE 115-a and base station 105-a, which may be examples of a UE 115 or a base station 105 and may communicate with one another as described above with reference to FIG. 1. Wireless communications subsystem 300 may also include downlink 305 and uplink 310.

In some examples, a base station 105 may transmit a reordering timer value 315 and transport blocks 320, which may include one or more RLC PDUs 325, to a UE 115 via downlink 305. The UE 115 may transmit a status report 330 to the base station 105 via uplink 310. In some cases, status report 330 is transmitted at the expiration of reordering timer 335, the duration of which may be modified by the UE 115 based on channel conditions experienced at different locations of a coverage area 110.

In the example of FIG. 3, base station 105-a may transmit reordering timer value 315 to UE 115-a, which may provide UE 115-a with a value for determining an initial duration for reordering timer 335. Subsequently, base station 105-a may transmit transport block 320 to UE 115-a. In the example of FIG. 3, UE 115-a may successfully receive the first, third, and fourth RLC PDUs 325 but may fail to successfully receive the second RLC PDU 325-a. Upon identifying that RLC PDU 325-a has not been received—e.g., by comparing SNs of the received RLC PDUs 325—UE 115-a may trigger reordering timer 335. After reordering timer 335 has expired, UE 115-a may transmit status report 330 to base station 105-a.

Status report 330 may include an indication of which RLC PDUs 325 were successfully received, or in some cases, which RLC PDUs 325 were not successfully received. For example, base station 105-a may use status report 330 to determine that RLC PDU 325-a was not successfully received and may retransmit RLC PDU 325-a as RLC PDU 325-b. In some examples, UE 115-a may successfully receive RLC PDU 325-a after transmitting status report 330 and, in some cases, may also successfully receive RLC PDU 325-b. Accordingly. UE 115-a may discard the duplicate transmission, RLC PDU 325-b. In other examples, UE 115-a may fail to receive RLC PDU 325-a after transmitting status report 330, but successfully receive RLC PDU 325-b.

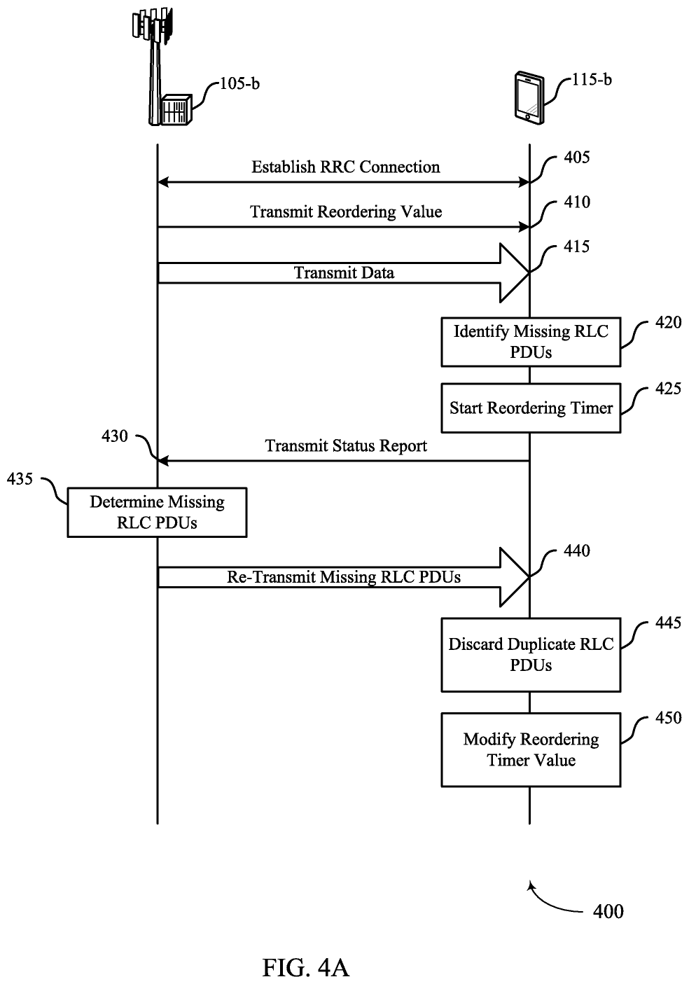

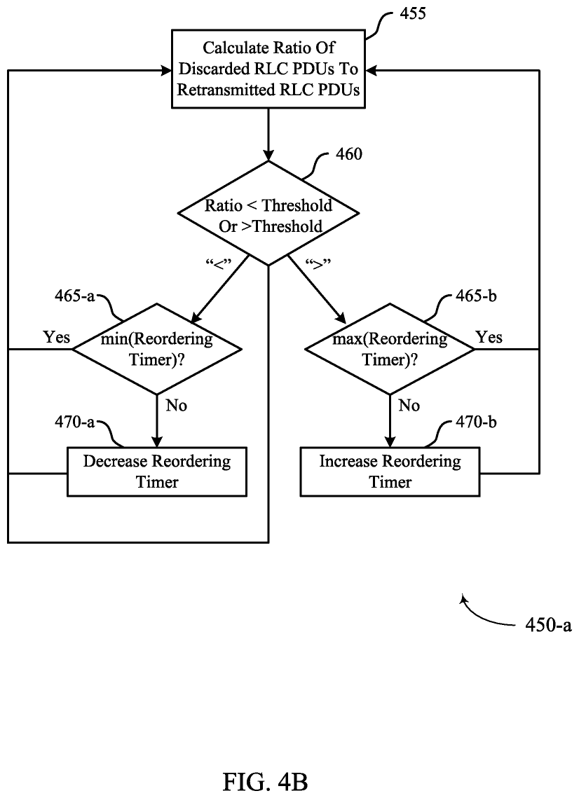

After identifying that RLC PDU 325-a has been missed, UE 115-a may update the received reordering timer value 315 based on channel conditions (e.g., a received signal strength indicator (RSSI), reference signal received power (RSRP), signal-to-noise ratio (SNR), reference signal received quality (RSRQ), a packet error rate, etc.) observed by UE 115-a. In some cases, UE 115-a may keep track of the number of retransmitted RLC PDUs 325 (e.g., RLC PDU 325-b) and the number of duplicate RLC PDUs 325 (e.g., if both RLC PDU 3250a and RLC PDU 325-b are successfully received). In some examples, UE 115-a may increment a counting variable that keeps track of retransmitted RLC PDUs 325 using the missing RLC PDU information indicated in the status report. The number of retransmitted and discarded RLC PDUs 325 may be indicative of channel conditions and used to update the received reordering timer value 315, as discussed in more detail below and with reference to FIG. 4B.

For instance, UE 115-a may calculate a ratio of discarded RLC PDUs 325 to retransmitted RLC PDUs 325. This ratio may be compared against a threshold, and in some cases, if the ratio is greater than the threshold, UE 115-a may increase the duration of the reordering timer 335—e.g., by increasing the current reordering timer value. The ratio being greater than the threshold may be indicative of the duration of the reordering timer 335 being shorter than a maximum HARQ process duration set by a MAC entity of either the base station 105-a or UE 115-a. In some cases, the maximum HARQ process duration may be set and/or modified by the MAC layer of UE 115-a or base station 105-a based on channel conditions or a radio resource configuration of UE 115-a.

While, in other cases, if the ratio is less than the threshold. UE 115-a may decrease the current reordering timer value. The ratio being less than the threshold may be indicative of the duration of reordering timer 335 being longer than the maximum HARQ duration or longer than the average HARQ process duration for successfully delivering a transport block. Additionally or alternatively, the ratio being less than the threshold may be indicative of poor channel conditions, in which a low percentage of transport blocks are not successfully transmitted within the maximum HARQ process duration. Therefore, a shorter duration for reordering timer 335 may increase the number of retransmissions and therefore the number of transport blocks that are received. UE 115-a may continue to update the ratio as subsequent RLC PDUs 325 are received as discussed above. In some examples, UE 115-a may calculate the ratio as above but may update the ratio only after observing a predetermined number of discarded or retransmitted RLC PDUs (e.g., 50, 100, etc.). In other examples, UE 115-a may use a predetermined value in the denominator of the ratio (e.g., 50, 100, etc.).

In some examples, base station 105-a may use a default value for a reordering timer at base station 105-a that is associated with uplink RLC PDU retransmissions. Base station 105-a may similarly adapt this default value for individual UEs, such as UE 115-a, based on channel conditions or radio resource configurations of the UEs. For instance, base station 105-a may maintain a ratio of discarded RLC PDUs to retransmitted RLC PDUs for incrementing/decrementing the default value.

FIG. 4A illustrates an example of a process flow 400 for flexibly determining a reordering value for RLC PDU retransmissions in accordance with various aspects of the present disclosure. Process flow 400 may be performed by UE 115-b and base station 105-b, which may be an example of a UE 115 and base station 105 described above with reference to FIGS. 1-2. In some examples, UE 115-b may modify a reordering timer value received from base station 105-b based on channel conditions experienced at different locations within a coverage area of base station 105-b.

At 405, base station 105-b and UE 115-b may establish an RRC connection. Establishing an RRC connection may include exchanging device parameters and system information between base station 105-b and UE 115-b. At 410, base station 105-b may transmit a value for a timer associated with retransmissions of RLC PDUs (“reordering timer”), which may be received by UE 115-b. In some cases, the value is included in RRC signaling transmitted while establishing the RRC connection.

At 415, base station 105-b may transmit data, which may be received by UE 115-b. As discussed with reference to FIG. 3, transport blocks may be used to transmit data, and each transport block may include one or more RLC PDUs. At 420, UE 115-b processes and decodes the received RLC PDUs and identifies whether there are missing RLC PDUs. In some cases, UE 115-b identifies missing RLC PDUs by comparing sequence numbers of the received RLC PDUs. At 425, UE 115-b may identify that an RLC PDU with a sequence number (e.g., N+2) that is greater than an expected sequence number (e.g., N) has been received and may start the reordering timer.

At 430, UE 115-b transmits a status report to base station 105-b at the expiration of the reordering timer. The status report may be used to communicate to base station 105-b which RLC PDUs have or have not been successfully received at UE 115-b. At 435, base station 105-b determines which RLC PDUs are missing based on the received status report. At 440, base station 105-b may re-transmit the RLC PDUs that have been identified as missing to UE 115-b. At 445, UE 115-b may discard duplicate RLC PDUs, which correspond to retransmit RLC PDUs whose original RLC PDU was successfully received at UE 115-b after requesting a retransmission of the original RLC PDU.

At 450 and after identifying that a request for the retransmission of a missing RLC PDU has been triggered, UE 115-b may modify the value of the reordering timer. Modifying the value of the reordering timer may include determining a second value for the reordering timer based on channel conditions observed by the UE or a radio resource configuration of the UE (e.g., multi-carrier configuration, eCC configuration, etc.), as discussed below and with reference to FIG. 4B. Subsequent RLC PDUs received by UE 115-b may be processed according to the second value for the timer. In some cases, modifying the reordering value may occur as early as immediately preceding the transmission of the status report. Aspects of the above operations may be repeated as additional RLC PDUs are received by UE 115-b, and third and fourth values for the reordering timer may be determined.

FIG. 4B illustrates an example of a flow chart 450-a for modifying a reordering timer value based on channel conditions in accordance with various aspects of the present disclosure and with reference to FIG. 4A. Operations of flow chart 450-a may be performed by UE 115-b or base station 105-b, as described above with reference to FIG. 4A. In some examples, a UE, such as UE 115-b, may perform the steps of flow chart 450-a to modify a reordering timer value received from a base station, such as base station 105-b. As discussed above. UE 115-b may keep track of the number of retransmitted RLC PDUs and the number of discarded RLC PDUs during operation (e.g., using a counter).

At 455, UE 115-b may calculate the ratio of discarded RLC PDUs to retransmitted RLC PDUs. In some cases, the ratio may be indicative of channel conditions or of a radio resource configuration of UE 115-b. In some cases, UE 115-b may determine a condition of the channel based on the number of discarded RLC PDUs and the number of retransmitted RLC PDUs. For instance, a high number of retransmitted RLC PDUs may be associated with poor channel conditions. In some examples, a high number of discarded RLC PDUs may be associated with an increased maximum HARQ duration associated with a radio resource configuration such as CA. In some cases and as discussed above, the frequency of retransmitted and discarded RLC PDUs may be based on a duration associated with the maximum number of HARQ retransmissions. UE 115-b may determine an average of the calculated ratio, for instance by using the equation:

$$Avg Ratio ( n + 1 ) = 1 + \frac{window size - 1}{window size} avg ratio ( n ) + \frac{1}{window size} latest ratio , \qquad ( 1 )$$

where the window size may be selected to be 16, 32, etc.

At 460, the ratio may be compared with one or more thresholds. In some cases, if the ratio is less than a first threshold, the method proceeds to 465-a; if the ratio is greater than a second threshold, the method proceeds to 465-b; or if the ratio is neither greater than nor less than the first or second thresholds, the method proceeds to 455. In some cases, a range of numbers is present between the first and second thresholds, which may be used as an equilibrium point for the reordering timer value. In some examples, the average ratio may be compared against the threshold values to compensate for short-term variations in channel conditions—e.g., due to hand block or isolated dead zones. The ratio being less than the first threshold may be indicative of the channel condition being less than a threshold. Similarly, the ratio being greater than the first threshold may be indicative of the channel condition being greater than a threshold.

At 465-a, IE 115-b may determine if a value of the reordering timer is at a predetermined minimum. According to the example of FIG. 4B, if the reordering timer value is at the predetermined minimum, the method proceeds to 455 without updating the reordering timer value. In some cases, a list including a range of reordering values is provided to UE 115-b. The smallest number of the list may be used as the minimum value and the largest number of the list may be used as the maximum value. If the reordering timer value is greater than the minimum reordering timer value, the method proceeds to 470-a. Similarly at 465-b, the reordering timer value may be compared with a maximum value. If the reordering timer is at the predetermined maximum, the method proceeds to 455; otherwise, the method proceeds to 470-b.

At 470-a, UE 115-b may decrease the value of the reordering timer. In some cases, the reordering timer may be decreased by selecting the lower entry than the current entry of the list of reordering timer values, where the lower entry is associated with a smaller reordering timer value. In another example, decreasing the reordering timer may be accomplished by decrementing the current reordering timer value by a predetermined value. In some examples, the value used to decrement the current reordering timer value may be based on the channel conditions and/or the current reordering timer value—e.g., may be larger or smaller based on the difference between the current reordering timer value and the minimum and/or maximum value. At 470-b, UE 115-b may similarly increase the value of the reordering timer, for instance using the techniques described above. The method may then return to 455 and repeat aspects of flow chart 450-a to determine another reordering timer value as channel conditions continue to vary or may maintain the reordering value as is if channel conditions remain constant.

Flow chart 450-a depicts example steps for modifying a reordering timer value. In other examples, UE 115-b may modify the reordering timer value based on receiving signaling that indicates a change in the radio resource configuration of UE 115-b. In some examples, UE 115-b may use reordering timer values that correspond to certain radio resource configuration. In other examples, UE 115-b may decrement/increment a current reordering timer value by values that correspond to certain radio resource configurations. The foregoing techniques for modifying a reordering value may be used alone or in combination with one another. Furthermore, although the adaptation of the reordering value of FIGS. 4A and 4B is generally discussed in the context of adaptation at UE 115-b, the foregoing discussion may be similarly applied at a base station 105-b.

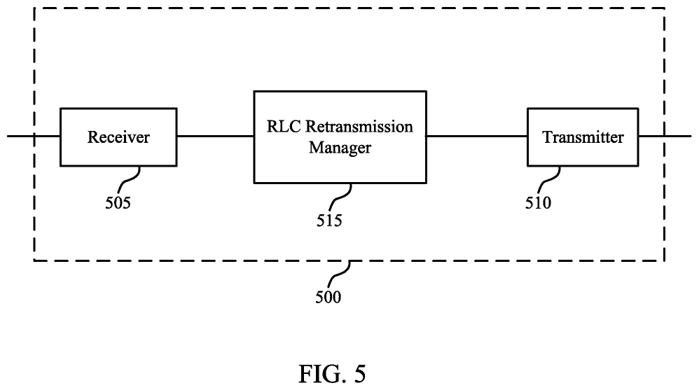

FIG. 5 shows a block diagram of a wireless device 500 that supports flexibly determining a reordering value for RLC PDU retransmissions in accordance with various aspects of the present disclosure. Wireless device 500 may be an example of aspects of a UE 115 or a base station 105 described with reference to FIGS. 1 and 2. Wireless device 500 may include receiver 505, transmitter 510 and RLC retransmission manager 515. Wireless device 500 may also include a processor. Each of these components may be in communication with one another.

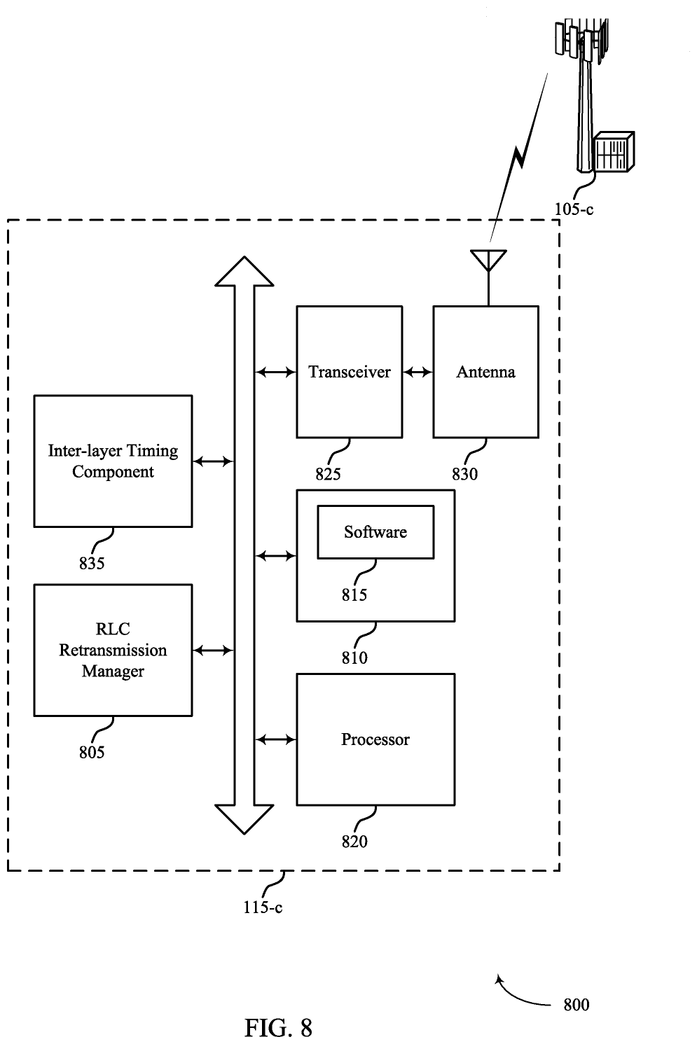

The receiver 505 may receive information such as packets, user data, or control information associated with various information channels (e.g., control channels, data channels, and information related to flexibly determining a reordering value for RLC PDU retransmissions, etc.). Information may be passed on to other components of the device. The receiver 505 may be an example of aspects of the transceiver 825 described with reference to FIG. 8.

The transmitter 510 may transmit signals received from other components of wireless device 500. In some examples, the transmitter 510 may be collocated with a receiver in a transceiver module. For example, the transmitter 510 may be an example of aspects of the transceiver 825 described with reference to FIG. 8. The transmitter 510 may include a single antenna, or it may include a plurality of antennas.

The RLC retransmission manager 515 may receive, from a wireless network, a first value for a timer associated with retransmissions of RLC PDUs, determine a second value for the timer based on a channel condition of the UE or a radio resource configuration of the UE, and process RLC PDUs based on the second value for the timer for the timer. The RLC retransmission manager 515 may also be an example of aspects of the RLC retransmission manager 805 described with reference to FIG. 8. In some examples, the UE determines a third value based at least in part on the first value and/or the second value. In this way, the UE may iteratively select additional values for the timer as channel conditions vary.

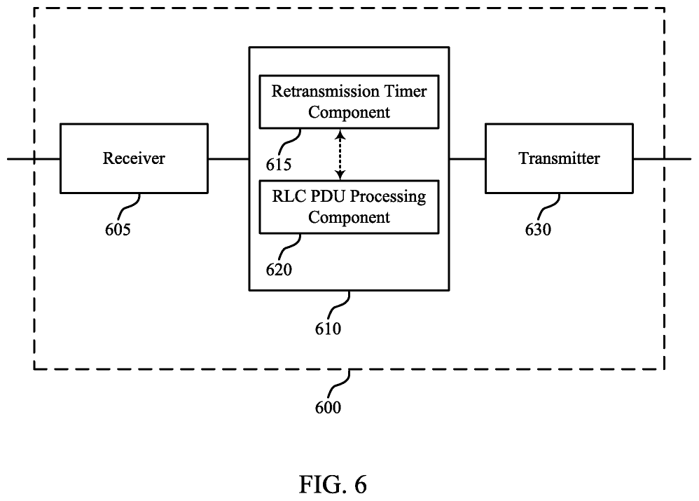

FIG. 6 shows a block diagram of a wireless device 600 that supports flexibly determining a reordering value for RLC PDU retransmissions in accordance with various aspects of the present disclosure. Wireless device 600 may be an example of aspects of a wireless device 500, a UE 115, or a base station as described with reference to FIGS. 1, 2 and 5. Wireless device 600 may include receiver 605, RLC retransmission manager 610 and transmitter 630. Wireless device 600 may also include a processor. Each of these components may be in communication with one another.

The receiver 605 may receive information which may be passed on to other components of the device. The receiver 605 may also perform the functions described with reference to the receiver 505 of FIG. 5. The receiver 605 may be an example of aspects of the transceiver 825 described with reference to FIG. 8.

The RLC retransmission manager 610 may be an example of aspects of RLC retransmission manager 610 described with reference to FIG. 5. The RLC retransmission manager 610 may include retransmission timer component 615 and RLC PDU processing component 620. The RLC retransmission manager 610 may be an example of aspects of the RLC retransmission manager 805 described with reference to FIG. 8.

The receiver 605 may receive, from a wireless network, a first value for a timer associated with retransmissions of RLC PDUs, and retransmission timer component 615 may determine a second value for the timer based on a channel condition of the UE or a radio resource configuration of the UE, or both. In some cases, determining the second value for the timer includes selecting the second value for the timer from a set of values that include the first value for the timer and the second value for the timer, where the second value for the timer is selected based on the first value for the timer, the channel condition, or the radio resource configuration of the UE, or any combination thereof.

The retransmission timer component 615 may also select a second value for the timer based on determining that the channel condition is greater than a threshold, where the second value for the timer is greater than the first value for the timer, or select the second value for the timer based on determining that the channel condition is less than the threshold, where the second value for the timer is less than the first value for the timer. The retransmission timer component 615 may also determine a third value for the timer based on the second value for the timer and the channel condition, where the third value for the timer is different from the first value for the timer or the second value for the timer, or both.

The RLC PDU processing component 620 may process RLC PDUs based on the second value for the timer or a third value for the timer. That is, subsequent RLC PDUs received at the RLC entity may be processed using an updated value for the reordering timer.

The transmitter 630 may transmit signals received from other components of wireless device 600. In some examples, the transmitter 630 may be collocated with a receiver in a transceiver module. For example, the transmitter 630 may be an example of aspects of the transceiver 825 described with reference to FIG. 8. The transmitter 630 may utilize a single antenna, or it may utilize a plurality of antennas.

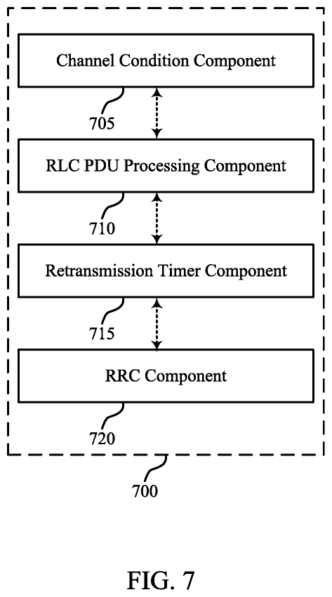

FIG. 7 shows a block diagram of a RLC retransmission manager 700 which may be an example of the corresponding component of wireless device 500 or wireless device 600. That is. RLC retransmission manager 700 may be an example of aspects of RLC retransmission manager 515 or RLC retransmission manager 610 described with reference to FIGS. 5 and 6. The RLC retransmission manager 700 may also be an example of aspects of the RLC retransmission manager 805 described with reference to FIG. 8.

The RLC retransmission manager 700 may include channel condition component 705, RLC PDU processing component 710, retransmission timer component 715 and RRC component 720. Each of these modules may communicate, directly or indirectly, with one another (e.g., via one or more buses).

The channel condition component 705 may determine the channel condition of the UE based on a number of discarded RLC PDUs or a number of retransmitted RLC PDUs, or both. In some cases, determining the channel condition of the F includes determining a ratio of discarded RLC PDUs to retransmitted RLC PDUs. In some cases, the duration of the HARQ process is associated with a maximum number of HARQ retransmissions. In some cases, the number of discarded RLC PDUs or the number of retransmitted RLC PDUs, or both, is based on a duration of a HARQ process (e.g., a maximum HARQ process duration).

In some cases, determining the second value for the timer includes determining that the channel condition is greater than a threshold. In some cases, determining the channel condition is greater than the threshold includes comparing a ratio of discarded RLC PDUs to retransmitted RLC PDUs with the threshold. In some cases, determining the second value for the timer includes determining that the channel condition is less than a threshold. In some examples, the second value for the timer is determined based at least in part on a duration defined with respect to media access control (MAC) layer operations, such as a HARQ process or maximum HARQ process duration.

The RLC PDU processing component 710 may process RLC PDUs based on the second value for the timer or a third value for the timer.

The retransmission timer component 715 may receive, from a wireless network, a first value for a timer associated with retransmissions of RLC PDUs, and determine a second value for the timer based on a channel condition of the UE or a radio resource configuration of the UE, or both. The retransmission timer component 715 may also select a second value for the timer based on determining that the channel condition is greater than a threshold, where the second value for the timer is greater than the first value for the timer, or select the second value for the timer based on determining that the channel condition is less than the threshold, where the second value for the timer is less than the first value for the timer. The retransmission timer component 715 may also determine a third value for the timer based on the second value for the timer and the channel condition, where the third value for the timer is different from the first value for the timer or the second value for the timer, or both.

The RRC component 720 may receive signaling that indicates a change in the radio resource configuration of the UE, where the second value for the timer is determined based on the change in the radio resource configuration. In some cases, a radio resource configuration of the UE includes a multi-carrier configuration or an eCC configuration.

FIG. 8 shows a diagram of a system 800 including a device that supports flexibly determining a reordering value for RLC PDU retransmissions in accordance with various aspects of the present disclosure. For example, system 800 may include UE 115-c, which may be an example of a wireless device 500, a wireless device 600, a UE 115 as described with reference to FIGS. 1, 2, and 5 through 7.

UE 115-c may also include RLC retransmission manager 805, memory 810, processor 820, transceiver 825, antenna 830 and inter-layer timing component 835. Each of these modules may communicate, directly or indirectly, with one another (e.g., via one or more buses). The RLC retransmission manager 805 may be an example of a RLC retransmission manager as described with reference to FIGS. 5 through 7.

The memory 810 may include random access memory (RAM) and read only memory (ROM). The memory 810 may store computer-readable, computer-executable software including instructions that, when executed, cause the processor to perform various functions described herein (e.g., flexibly determining a reordering value for RLC PDU retransmissions, etc.). In some cases, the software 815 may not be directly executable by the processor but may cause a computer (e.g., when compiled and executed) to perform functions described herein. The processor 820 may include an intelligent hardware device, (e.g., a central processing unit (CPU), a microcontroller, an application specific integrated circuit (ASIC), etc.)

The transceiver 825 may communicate hi-directionally, via one or more antennas, wired, or wireless links, with one or more networks, as described above. For example, the transceiver 825 may communicate bi-directionally with a base station 105, such as base station 105-c, or a UE 115. The transceiver 825 may also include a modem to modulate the packets and provide the modulated packets to the antennas for transmission, and to demodulate packets received from the antennas. In some cases, the wireless device may include a single antenna 830. However, in some cases the device may have more than one antenna 830, which may be capable of concurrently transmitting or receiving multiple wireless transmissions.

The inter-layer timing component 835 may enable operations tailored to different configurations or conditions by adjusting procedures associated with a radio link control (RLC) layer by reference to a value defined at a medium access control (MAC). For example, inter-layer timing component 835 may identify intervals or durations of one layer (e.g., MAC layer) during which operations or values associated with another layer (e.g., RLC layer) are assessed. Inter-layer timing component 835 may determine a ratio of discarded RLC PDUs to retransmitted PDUs during an interval defined at the MAC layer for HARQ operations, for example. In some examples, the above components, devices, software, etc. may be similarly implemented in a base station such as base station 105-c.

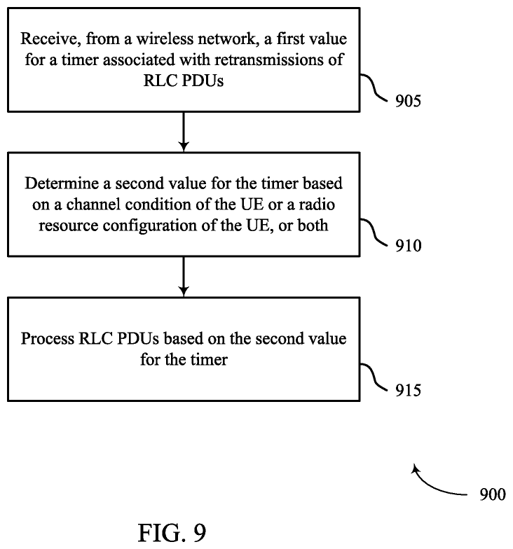

FIG. 9 shows a flowchart illustrating a method 900 for flexibly determining a reordering value for RLC PDU retransmissions in accordance with various aspects of the present disclosure. The operations of method 900 may be implemented by a device such as a UE 115 or its components as described with reference to FIGS. 1 and 2. For example, the operations of method 900 may be performed by the RLC retransmission manager as described herein. In some examples, the UE 115 may execute a set of codes to control the functional elements of the device to perform the functions described below. Additionally or alternatively, the UE 115 may perform aspects the functions described below using special-purpose hardware.

At block 905, the UE 115 may receive, from a wireless network, a first value for a timer associated with retransmissions of RLC PDUs as described above with reference to FIGS. 2 through 4. In certain examples, the operations of block 905 may be performed by the retransmission timer component as described with reference to FIGS. 6 and 7.

At block 910, the UE 115 may determine a second value for the timer based on a channel condition of the UE or a radio resource configuration of the UE, or both as described above with reference to FIGS. 2 through 4. In certain examples, the operations of block 910 may be performed by the retransmission timer component as described with reference to FIGS. 6 and 7.

At block 915, the UE 115 may process RLC PDUs based on the second value for the timer as described above with reference to FIGS. 2 through 4. In certain examples, the operations of block 915 may be performed by the RLC PDU processing component as described with reference to FIGS. 6 and 7.

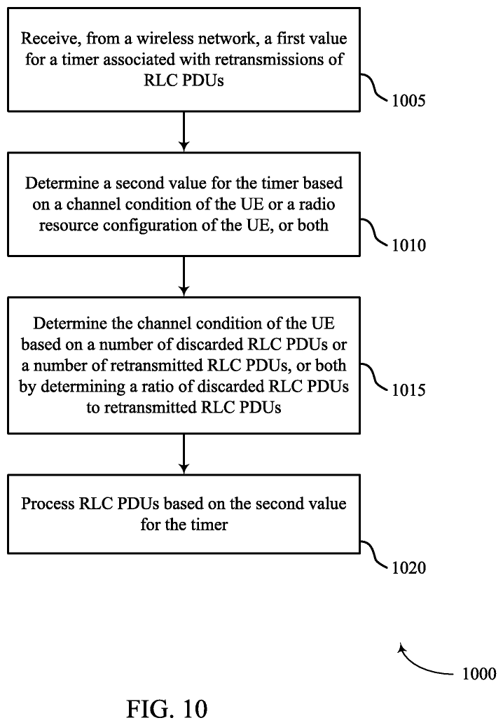

FIG. 10 shows a flowchart illustrating a method 1000 for flexibly determining a reordering value for RLC PDU retransmissions in accordance with various aspects of the present disclosure. The operations of method 1000 may be implemented by a device such as a UE 115 or its components as described with reference to FIGS. 1 and 2. For example, the operations of method 1000 may be performed by the RLC retransmission manager as described herein. In some examples, the UE 115 may execute a set of codes to control the functional elements of the device to perform the functions described below. Additionally or alternatively, the UE 115 may perform aspects the functions described below using special-purpose hardware.

At block 1005, the UE 115 may receive, from a wireless network, a first value for a timer associated with retransmissions of RLC PDUs as described above with reference to FIGS. 2 through 4. In certain examples, the operations of block 1005 may be performed by the retransmission timer component as described with reference to FIGS. 6 and 7.

At block 1010, the UE 115 may determine a second value for the timer based on a channel condition of the UE or a radio resource configuration of the UE, or both as described above with reference to FIGS. 2 through 4. In certain examples, the operations of block 1010 may be performed by the retransmission timer component as described with reference to FIGS. 6 and 7.

At block 1015, the UE 115 may determine the channel condition of the UE based on a number of discarded RLC PDUs or a number of retransmitted RLC PDUs, or both as described above with reference to FIGS. 2 through 4. In some cases, determining the channel condition of the UE includes determining a ratio of discarded RLC PDUs to retransmitted RLC PDUs. In certain examples, the operations of block 1015 may be performed by the channel condition component as described with reference to FIGS. 6 and 7.

At block 1020, the IE 115 may process RLC PDUs based on the second value for the timer as described above with reference to FIGS. 2 through 4. In certain examples, the operations of block 1020 may be performed by the RLC PDU processing component as described with reference to FIGS. 6 and 7.

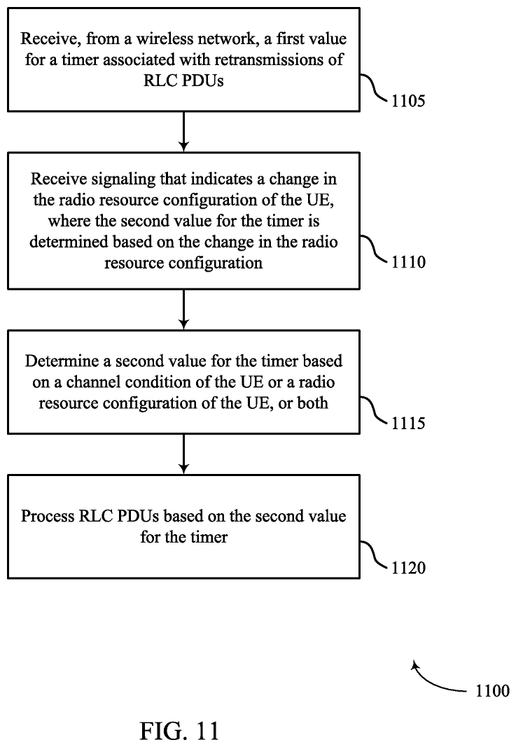

FIG. 11 shows a flowchart illustrating a method 1100 for flexibly determining a reordering value for RLC PDU retransmissions in accordance with various aspects of the present disclosure. The operations of method 1100 may be implemented by a device such as a UE 115 or its components as described with reference to FIGS. 1 and 2. For example, the operations of method 1100 may be performed by the RLC retransmission manager as described herein. In some examples, the UE 115 may execute a set of codes to control the functional elements of the device to perform the functions described below. Additionally or alternatively, the UE 115 may perform aspects the functions described below using special-purpose hardware.

At block 1105, the UE 115 may receive, from a wireless network, a first value for a timer associated with retransmissions of RLC PDUs as described above with reference to FIGS. 2 through 4. In certain examples, the operations of block 1105 may be performed by the retransmission timer component as described with reference to FIGS. 6 and 7.

At block 1110, the UE 115 may receive signaling that indicates a change in the radio resource configuration of the UE, where the second value for the timer is determined based on the change in the radio resource configuration as described above with reference to FIGS. 2 through 4. In certain examples, the operations of block 1110 may be performed by the RRC component as described with reference to FIGS. 6 and 7.

At block 1115, the UE 115 may determine a second value for the timer based on a channel condition of the UE or a radio resource configuration of the UE, or both as described above with reference to FIGS. 2 through 4. In certain examples, the operations of block 1115 may be performed by the retransmission timer component as described with reference to FIGS. 6 and 7.

At block 1120, the UE 115 may process RLC PDUs based on the second value for the timer as described above with reference to FIGS. 2 through 4. In certain examples, the operations of block 1120 may be performed by the RLC PDU processing component as described with reference to FIGS. 6 and 7.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for flexibly determining a reordering value for RLC PDU retransmissions.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical (PHY) locations. Also, as used herein, including in the claims, “or” as used in a list of items (for example, a list of items prefaced by a phrase such as “at least one of or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (IRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11, IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an access point (AP), a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies. In some cases, different coverage areas may be associated with different communication technologies. In some cases, the coverage area for one communication technology may overlap with the coverage area associated with another technology. Different technologies may be associated with the same base station, or with different base stations.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and subsystem 300 of FIGS. 1 and 3 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD)(e.g., using paired spectrum resources) or TDD operation (e.g., using unpaired spectrum resources). Frame structures may be defined for FDD (e.g., frame structure type 1) and TDD (e.g., frame structure type 2).

Thus, aspects of the disclosure may provide for flexibly determining a reordering value for RLC PDU retransmissions. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
receiving, from a wireless network, a first value for a timer associated with retransmissions of radio link control (RLC) packet data units (PDUs);
determining a second value for the timer based at least in part on a channel condition of the user equipment (UE) or a radio resource configuration of the UE, or both; and
processing RLC protocol data units (PDUs) based at least in part on the second value for the timer.

2. The method of claim 1, further comprising:
determining the channel condition of the UE based at least in part on a number of discarded RLC PDUs or a number of retransmitted RLC PDUs, or both.

3. The method of claim 2, wherein determining the channel condition of the UE comprises:
determining a ratio of discarded RLC PDUs to retransmitted RLC PDUs.

4. The method of claim 2, wherein the number of discarded RLC PDUs or the number of retransmitted RLC PDUs, or both, is based at least in part on a duration of a hybrid automatic repeat request (HARQ) process.

5. The method of claim 4, wherein the duration of the HARQ process is associated with a maximum number of HARQ retransmissions.

6. The method of claim 1, wherein determining the second value for the timer comprises:
selecting the second value for the timer from a set of values that comprise the first value for the timer and the second value for the timer, wherein the second value for the timer is selected based at least in part on the first value for the timer, the channel condition, or the radio resource configuration of the UE, or any combination thereof.

7. The method of claim 1, wherein determining the second value for the timer comprises:
determining that the channel condition is greater than a threshold; and
selecting the second value for the timer based at least in part on determining that the channel condition is greater than the threshold, wherein the second value for the timer is greater than the first value for the timer.

8. The method of claim 7, wherein determining the channel condition is greater than the threshold comprises:
comparing a ratio of discarded RLC PDUs to retransmitted RLC PDUs with the threshold.

9. The method of claim 1, wherein determining the second value for the timer comprises:
determining that the channel condition is less than a threshold; and
selecting the second value for the timer based at least in part on determining that the channel condition is less than the threshold, wherein the second value for the timer is less than the first value for the timer.

10. The method of claim 1, wherein the radio resource configuration of the UE comprises a multi-carrier configuration.

11. The method of claim 1, further comprising:
receiving signaling that indicates a change in the radio resource configuration of the UE, wherein the second value for the timer is determined based at least in part on the change in the radio resource configuration.

12. The method of claim 1, wherein the second value for the timer is determined based at least in part on a duration defined with respect to media access control (MAC) layer operations.

13. An apparatus for wireless communication comprising:
means for receiving, from a wireless network, a first value for a timer associated with retransmissions of radio link control (RLC) packet data units (PDUs);
means for determining a second value for the timer based at least in part on a channel condition of the user equipment (UE) or a radio resource configuration of the UE, or both; and
means for processing RLC protocol data units (PDUs) based at least in part on the second value for the timer.

14. The apparatus of claim 13, further comprising:
means for determining the channel condition of the UE based at least in part on a number of discarded RLC PDUs or a number of retransmitted RLC PDUs, or both.

15. The apparatus of claim 14, wherein the means for determining the channel condition of the UE comprises:
means for determining a ratio of discarded RLC PDUs to retransmitted RLC PDUs.

16. The apparatus of claim 14, wherein the number of discarded RLC PDUs or the number of retransmitted RLC PDUs, or both, is based at least in part on a duration of a hybrid automatic repeat request (HARQ) process.

17. The apparatus of claim 15, wherein the duration of the HARQ process is associated with a maximum number of HARQ retransmissions.

18. The apparatus of claim 13, wherein the means for determining the second value for the timer comprises:
means for selecting the second value for the timer from a set of values that comprise the first value for the timer and the second value for the timer, wherein the means for selecting the second value for the timer is operable based at least in part on the first value for the timer, the channel condition, or the radio resource configuration of the UE, or any combination thereof.

19. The apparatus of claim 13, wherein the means for determining the second value for the timer comprises:
means for determining that the channel condition is greater than a threshold, wherein the means for selecting the second value for the timer is operable based at least in part on a determination that the channel condition is greater than the threshold, wherein the second value for the timer is greater than the first value for the timer.

20. The apparatus of claim 19, wherein the means for determining that the channel condition is greater than the threshold comprises:
means for comparing a ratio of discarded RLC PDUs to retransmitted RLC PDUs with the threshold.

21. The apparatus of claim 13, wherein the means for determining that the second value for the timer comprises:
means for determining that the channel condition is less than a threshold, wherein the means for selecting the second value for the timer is operable based at least in part on a determination that the channel condition is less than the threshold, wherein the second value for the timer is less than the first value for the timer.

22. The apparatus of claim 13, wherein the radio resource configuration of the UE comprises a multi-carrier configuration.

23. The apparatus of claim 13, further comprising:
means for receiving signaling that indicates a change in the radio resource configuration of the UE, wherein the means for determining the second value for the timer is operable based at least in part on a determination that the change in the radio resource configuration.

24. An apparatus for wireless communication, comprising:
a processor;
memory in electronic communication with the processor; and
instructions stored in the memory and operable, when executed by the processor, to cause the apparatus to:
receive, from a wireless network, a first value for a timer associated with retransmissions of radio link control (RLC) packet data units (PDUs);
determine a second value for the timer based at least in part on a channel condition of the user equipment (UE) or a radio resource configuration of the UE, or both; and
process RLC protocol data units (PDUs) based at least in part on the second value for the timer.

25. The apparatus of claim 24, wherein the instructions are operable to cause the apparatus to:
determine the channel condition of the UE based at least in part on a number of discarded RLC PDUs or a number of retransmitted RLC PDUs, or both.

26. The apparatus of claim 25, wherein the instructions are operable to cause the apparatus to:
determine a ratio of discarded RLC PDUs to retransmitted RLC PDUs.

27. The apparatus of claim 25, wherein the number of discarded RLC PDUs or the number of retransmitted RLC PDUs, or both, is based at least in part on a duration of a hybrid automatic repeat request (HARQ) process.

28. The apparatus of claim 27, wherein the duration of the HARQ process is associated with a maximum number of HARQ retransmissions.

29. The apparatus of claim 24, wherein the instructions are operable to cause the apparatus to:
select the second value for the timer from a set of values that comprise the first value for the timer and the second value for the timer; and
select the second value for the timer based at least in part on the first value for the timer, the channel condition, or the radio resource configuration of the UE, or any combination thereof.

30. The apparatus of claim 24, wherein the instructions are operable to cause the apparatus to:
determine that the channel condition is greater than a threshold; and
select the second value for the timer based at least in part on a determination that the channel condition is greater than the threshold, wherein the second value for the timer is greater than the first value for the timer.

31. The apparatus of claim 30, wherein the instructions are operable to cause the apparatus to:
compare a ratio of discarded RLC PDUs to retransmitted RLC PDUs with the threshold.

32. The apparatus of claim 24, wherein the instructions are operable to cause the apparatus to:
determine that the channel condition is less than a threshold; and
select the second value for the timer based at least in part on a determination that the channel condition is less than the threshold, wherein the second value for the timer is less than the first value for the timer.

33. The apparatus of claim 24, wherein the radio resource configuration of the UE comprises a multi-carrier configuration.

34. The apparatus of claim 24, wherein the instructions are operable to cause the apparatus to:
receive signaling that indicates a change in the radio resource configuration of the UE; and
determine the second value for the timer based at least in part on the change in the radio resource configuration.

35. A non-transitory computer-readable medium storing code for wireless communication, the code comprising instructions executable to:
receive, from a wireless network, a first value for a timer associated with retransmissions of radio link control (RLC) packet data units (PDUs);
determine a second value for the timer based at least in part on a channel condition of the user equipment (UE) or a radio resource configuration of the UE, or both; and
process RLC protocol data units (PDUs) based at least in part on the second value for the timer.
